(19) United States
(12) Patent Application Publication
(10) Pub. No.: US 2024/0374977 A1
(43) Pub. Date: Nov. 14, 2024

(54) CUSTOMIZED SPORTS TRAINING METHOD AND SYSTEM

(71) Applicant: Eagleford Tech Solutions, LLC, Austin, TX (US)

(72) Inventor: Agneesh Banerjee, Austin, TX (US)

(21) Appl. No.: 18/144,519

(22) Filed: May 8, 2023

(51) Int. Cl. A63B 24/00; A63B 69/00; A63B 71/06

(52) U.S. Cl. CPC A63B 69/002; A63B 71/0622; G09B 7/00; A63B 2214/00; A63B 2243/007

(57) ABSTRACT

A customized sports training system includes a design portal enabling a coach to design training material via an input method. The training material includes customized play designs, formations, quizzes, and various scenarios a player might experience during game play. This material is presented in the form of training sessions. The coach, via the system, may upload the training material to a database or servers for storage. The player, via an AR/VR device using the system or a third party application, is configured to access and execute the custom training sessions. The results of the sessions are saved for review by the coach.

### CROSS-REFERENCE TO RELATED APPLICATIONS

N/A

### BACKGROUND OF THE INVENTION

### 1. Field of the Invention

The present invention relates to sports training but more particularly a customized sports training method and system.

### 2. Description of Related Art

For applicable sports, such as football, learning the team's playbook is a critical mental aspect of being prepared as a player. Coaches expect the players on the team to know the plays and to know where each player is expected to line up before the play begins, and what their assignment is during the play.

Some training programs exist that allow players to review or view pre provided or selected common plays, however due to the lack of customization, the usefulness of the training programs are lacking. Consequently, there is room for improvement in this field.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is a particular object of the invention to provide the ability for a coach to upload custom training material, including offensive and defensive plays formations, quizzes, questions, or similar, to a training session hosted on a training application system such that a player may access the custom training material via the training application system.

In order to do this, in one aspect of the invention, a customized sports training system is provided, comprising a training application software system executed from one or more internet-connected servers connected to a data storage location, wherein the training application system software enables users to access the customized sports training system, the users including a coach and players; the customized sports training system including a design portal enabling the coach to design training material via an input method and then upload the training material to the database or the one or more internet-connected servers for storage; and, wherein the player is enabled, via the customized sports training system, to access the stored training material during an executed training session, wherein the executed training session displays the stored training material to the player on a user device.

In one embodiment, the training material includes custom designed football plays including offensive and defensive play designs. In another embodiment, the user device is an augmented reality or virtual reality device. In one embodiment, the input method of the training material is in a first format, the stored training material is in a second format, and the displayed training material is a third format. In another embodiment, the first format, the second format, and the third format is different. In yet another embodiment, the training application software transforms and converts the first format to the second format, and the second format to the third format. In one embodiment, the training session is a number of training materials. In one embodiment, the training materials include custom designed football plays, quizzes, scenarios, formations, and in-game situations.

In another aspect of the invention, a customized sports training system is provided, comprising a training application software system executed from one or more internet-connected central servers connected to a database, wherein the training application system software enables users to access the customized sports training system, the users including a coach and a player; the coach when accessing the customized sports training system enabled to: (a) create customized football plays; (b) create customized training sessions comprising of one or more customized football plays; and, (c) upload the created customized training sessions to the one or more internet-connected central servers or the database; the player when accessing the customized sports training system enabled to: (d) select their name or playing position; (e) execute a previously created customized training session via a user device; the customized sports training system providing customized training session results after step (e) accessible by the player and the coach, and, (f) results posted to a centralized leaderboard where scores are ranked against other users who completed the same session.

In one embodiment, the user device is an augmented reality or virtual reality device. In another embodiment, the virtual reality device is a virtual reality headset. In one embodiment, the customized football plays are created via an input method. In one embodiment, the input method is a drag and drop method or grid method. In one embodiment, the customized training sessions further comprise in-game scenarios, questions, or quizzes. In another embodiment, the created customized football plays are created for individual players or positions.

In yet another aspect of the invention, a customized sports training method is provided, comprising steps: (a) enabling, via a training application system platform, a coach to design custom training material via an input method; (b) uploading, via the training application system platform, the custom training material to a server or database; and, (c) enabling, via the training application system platform, a player to execute the training material on a user device.

In one embodiment, in step (a), the custom training material is for a specific playing position. In another embodiment, in step (c), wherein the player selects the specific playing position. In one embodiment, in step (a), the custom training material includes customized football plays. In one embodiment, the user device is an augmented reality or virtual reality device.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a network diagram of the customized sports training system according to an embodiment of the present invention;

FIG. 2 is a flow diagram of the customized sports training system method and system according to an embodiment of the present invention;

FIG. 3 is a flow diagram illustrating the upload process of training material according to an embodiment of the present invention;

FIG. 4 is a flow diagram of the customized sports training system method and system according to an embodiment of the present invention;

FIGS. 5-11 illustrate a coach's user interface of a training application system according to an embodiment of the present invention; and,

FIG. 12 is a flow diagram of the customized sports training system and display format types according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a customized sports training method and system.

Advantageously, the present invention enables a coach or trainer to design custom sports training material catered to individuals, specific playing positions, including both offensive and defensive players, and utilize the custom sports training materials in custom training sessions which are configured to be executed by the players via a user device, such as an AR/VR device. It should also be noted that although the present disclosure and figures are directed to American football, the present invention may apply to other sports, including not limited to soccer, basketball, volleyball, hockey, baseball, rugby, cricket, automobile racing, or other team or individual sports.

It is to be understood that the terminology used herein is for the purpose of describing particular embodiments only and is not intended to be limiting. The terms “a” or “an,” as used herein, are defined as to mean “at least one.” The term “plurality,” as used herein, is defined as two or more. The term “another,” as used herein, is defined as at least a second or more. The terms “including” and/or “having,” as used herein, are defined as comprising (i.e., open language). The term “providing” is defined herein in its broadest sense, e.g., bringing/coming into physical existence, making available, and/or supplying to someone or something, in whole or in multiple parts at once or over a period of time. These terms generally refer to a range of numbers that one of skill in the art would consider equivalent to the recited values (i.e., having the same function or result). In many instances these terms may include numbers that are rounded to the nearest significant figure. The term “training material” includes any type of training material known in the art, including but not limited to plays, formations, quizzes, questions, situations, or similar as well as the collection of training material formed into one or more training sessions. The term “coach” includes any user of the system with the authority to upload training material to the system. The term “player” includes any user configured to access the uploaded training material for study, training, assessment, etc.

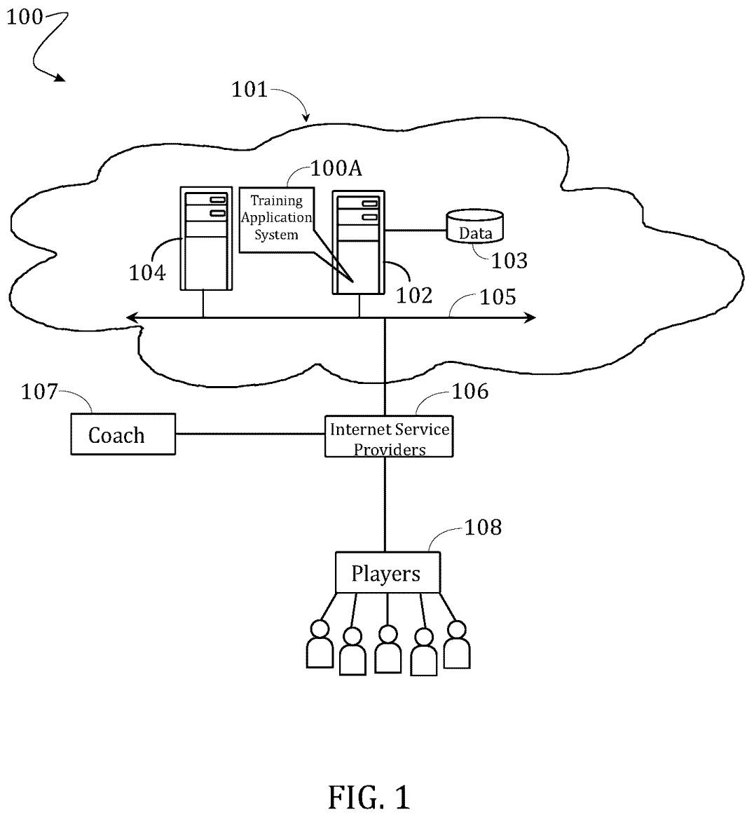

FIG. 1 is a network diagram of the customized sports training system 100 according to an embodiment of the present invention. Referring to FIG. 1, the system comprises one or more internet-connected servers 102 executing training application system software 100A from non-transitory media. Server 102 is connected to a data repository 103, which may be any sort of data storage known in the art. The system further comprises a third party internet-connected server 104 connected to internet backbone 105. Although one third party internet-connected server 104 is shown, it is understood that potentially millions of other similar servers are connected to the internet via internet backbone 105. One or more coaches 107 and a number of players 108 are connected to the internet-connected central server 102 via an internet service provider (ISP) 106, allowing the one or more coaches 107 and the number of users 108 to access the training application system software 100A.

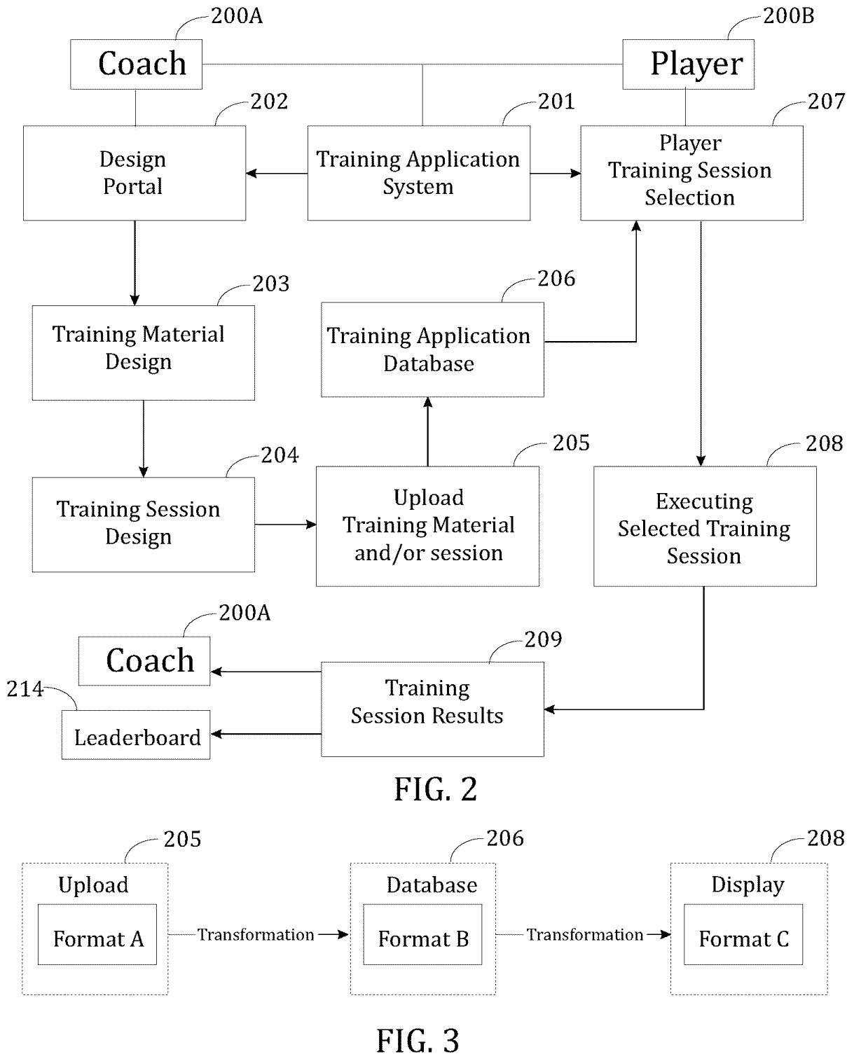

FIG. 2 is a flow diagram of the customized sports training method according to an embodiment of the present invention. Referring now to FIG. 2, the customized sports training method and system includes a coach 200A and a player 200B. It should be understood that the term “player” or “coach” may be used synonymous with “user.”Generally, a coach 200A or authoritative figure, trainer etc., logs on the training application system 201 using authorization credentials as well known in the art. Next in step 202, the coach may access the design portal enabling the ability to design and create training material 203 and training sessions 204. The coach may also load, edit, and import existing training material and sessions.

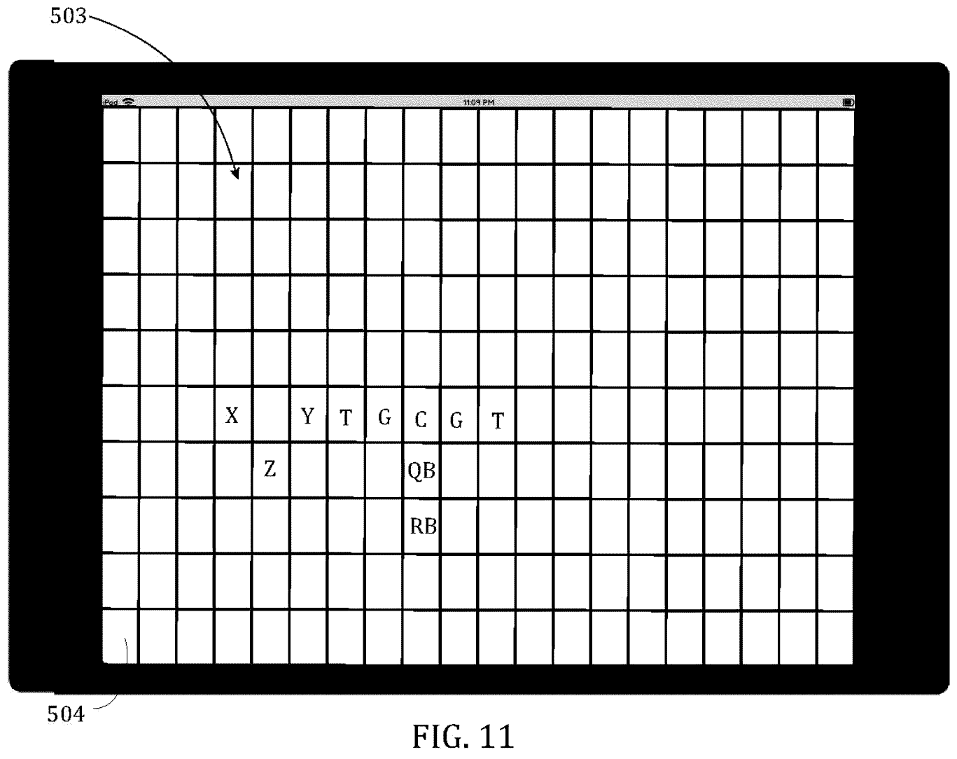

It will be appreciated that several design environments may be utilized for designing and creating training materials and sessions. The term “input method” is defined as the creation and designing of training materials and sessions on a front end interface, via the training application system, such that they can be uploaded to the database or server as will be discussed below. It should also be understood that the input method varies depending on the type of training material and/or session being created or designed. For example, in one embodiment, an input method for a training play, e.g. an offensive and defensive play, is a drag and drop style interface, best seen in FIG. 10. In this input method, the coach may drag and drop objects 501 representing players onto a virtual field 502. The coach can add text, symbols, lines, notes, etc. as necessary. In another example, shown in FIG. 11, the input method is a grid 503 wherein each cell 504 of the grid represents a preset amount of space on the field, such as 1 yard by 1 yard. The grid enables the coach to enter positions corresponding to field coordinates. As one skilled in the art can appreciate several other input methods may be utilized.

Stiff referring to FIG. 2, next, in step 205, after the coach designs, inputs, etc. a training material design, such as a play as described above, the training material design or training session design is uploaded to the training application database 206. In other embodiments, the training material design or training sessions are stored on the server. Further, as previously discussed, a training session is one or more training material designs, questions, queries, quizzes, tests, etc.

Once the training material is in the database (or server), the player 200B may access the training application system 201 using login credentials, and select an available player training session 207 that was previously uploaded to the database by a coach or trainer for that individual or specific player position. Next, in step 208 the player executes the selected training session, i.e. performs the test, reads the plays, takes the quiz, etc. Next, in step 209, the training session results are provided to the coach 200A. In other embodiments, the training session results are provided to both the player 200B and the coach 200A. In yet another embodiment, the training session results are provided to a leaderboard 214, which will be discussed in further details below.

Referring now to FIG. 3, the upload process of training material is illustrated. As previously discussed, the input method of the training material may vary, wherein the input method defines a format, e.g. format A. Advantageously, the training application provides a format conversion process from the upload step 205 to the database 206. Simply put, the system converts one format to another for storage into the database, e.g. format B, then interprets this format into a visual representation of format A, e.g. format C during the training session 208 executed by the player. It should be understood that the specific program languages, format types, etc. may vary. In one embodiment, a C #application is used to transform the uploaded input method into a JSON file format that is stored on the database (103; FIG. 1). When necessary, the system can retrieve the stored JSON file from the database, and display and present the training material to the player for execution. In alternative embodiments, the JSON file may be stored on the server (102; FIG. 1). The file types are merely provided as an example, and should not be construed as limiting. The critical aspect is that a coach or trainer, via the system, is enabled to design and upload custom play designs (training material) and/or training sessions, which are converted from their native format to a storage format, wherein the storage format is retrieved, read, and displayed in a format suitable for display, i.e. a visual representation of the play design, training material, and/or training session in the front end user interface on their computing device. In some embodiments, the training sessions are intended to be presented to the players in a virtual reality VR or augmented reality AR environment. In this example, the players are submerged into the AR/VR environment during the training session.

In alternative embodiments, the player is configured to access the stored training sessions via a third party application, using their AR/VR device. More specifically, the third party application is configured to communicate, access, and/or read a file containing the training sessions generated and created by the training application system. Then, the third application may display the training sessions to the player via their device. Advantageously, this enables the custom training sessions and training material created be accessible by various 3rd party AR/VR sports training devices.

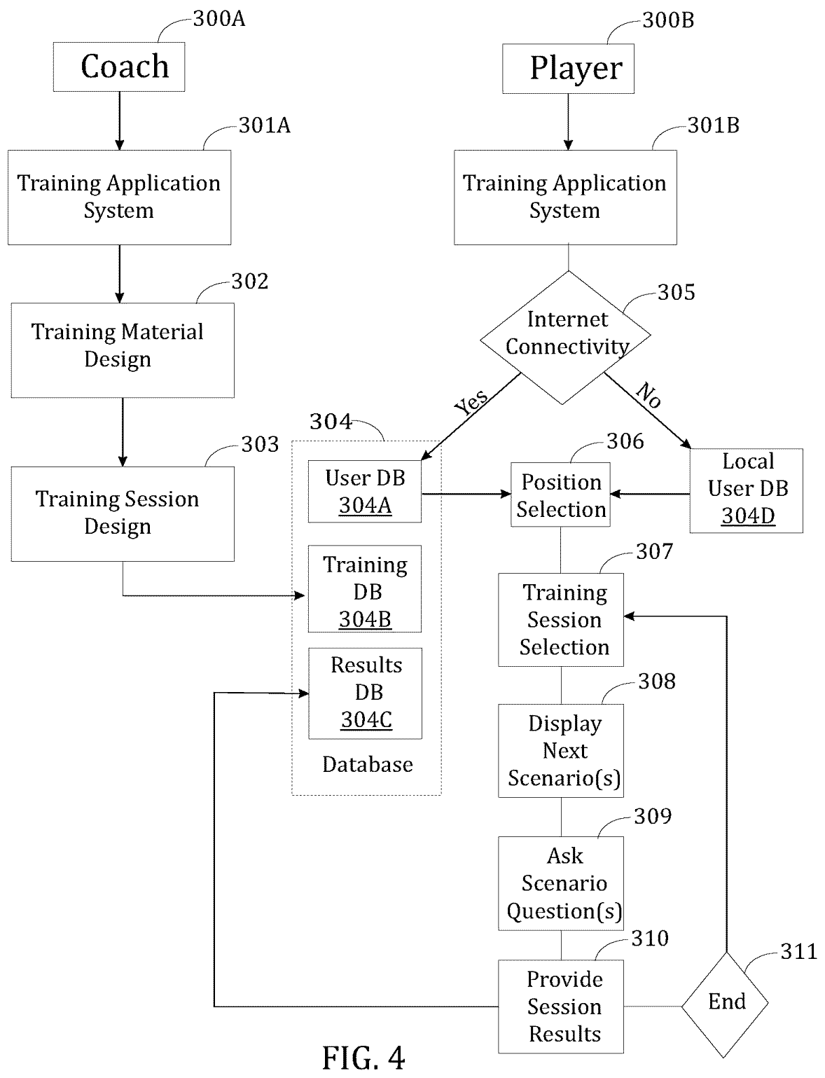

FIG. 4 is a flow diagram of the customized sports training system method and system. Referring now to FIG. 4, the customized sports training method and system includes a coach 300A and a player 300B, both enabled to log in and access a training application system (301A/B). The system access is dependent upon the user type and credentials. For the coach 300A, after accessing the system they are enabled to design training materials 302 and training sessions 303 as previously discussed. Once uploaded, the training material is stored into a training material database 304B.

Moving to the player 300B, after executing the application system software, a determination is made if the user has Internet connectivity 305. If yes, the user is queried to select their position 306, i.e. the position the player plays during games, e.g. quarterback. If not, the user is also queried to select their position 306, however if the user is online, the system accesses the user database 304A from the server's database 304, otherwise the system accesses the user's local database 304D on their computing machine. What is provided locally is outside the scope of the invention, however as well known in the art, a user may download files, such as training sessions, to their local device/computing machine for offline access.

After the user selects their position, a training session is selected 307, wherein the training session was previously inputted to the system by coach 300A for that position. Next, the player goes through the scenarios 308 of that training session, and asks the scenario questions 309 provided. The scenarios and questions continue until complete, i.e. there may be more than one scenario and associated questions. After the training session is complete, the results are provided 310 and sent to the results database 304C, wherein the coach 300A may access the results at any time. Finally, the player may end the training session 311, repeat the session, or select a different session.

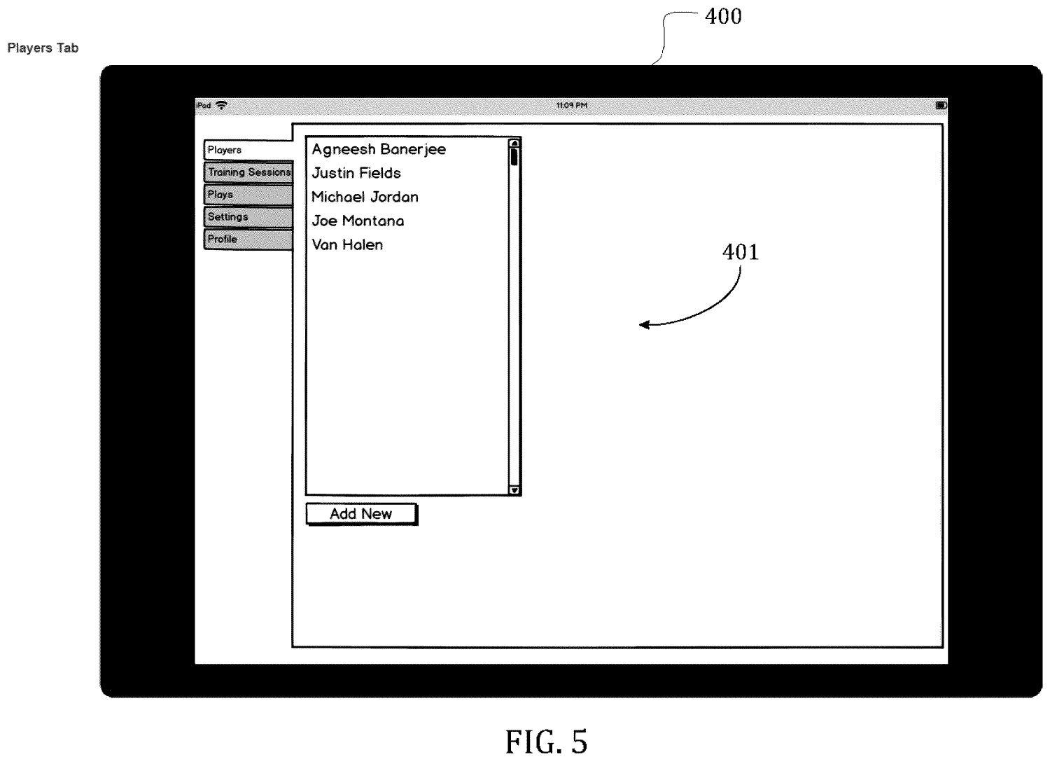

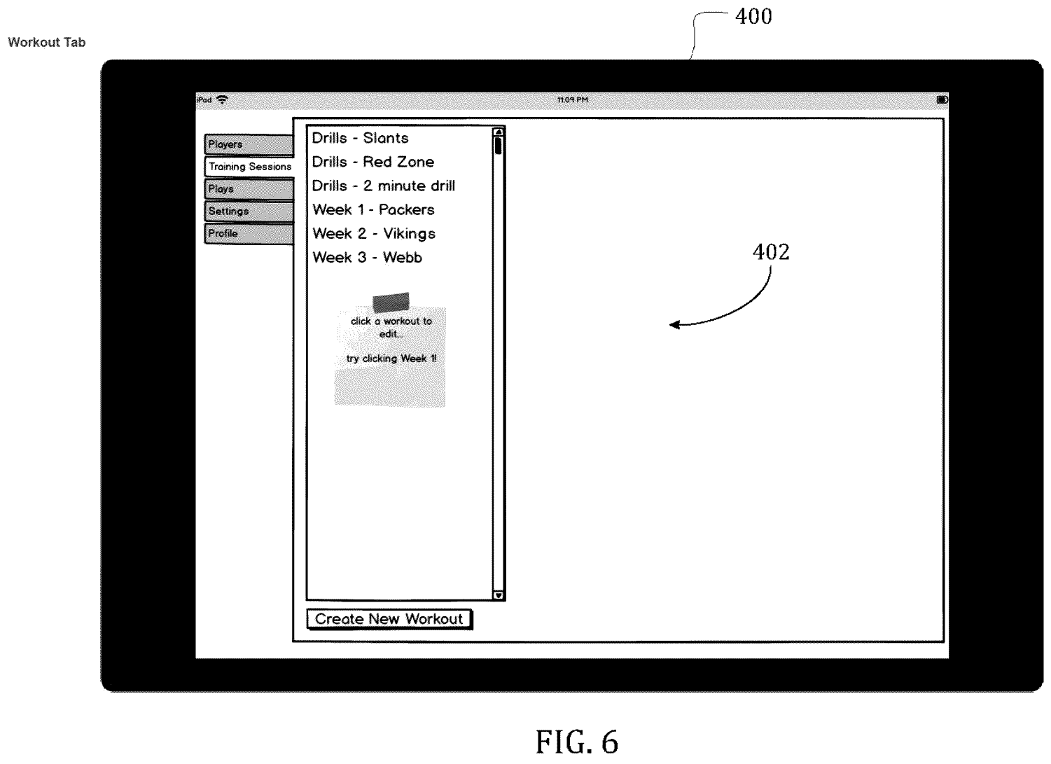

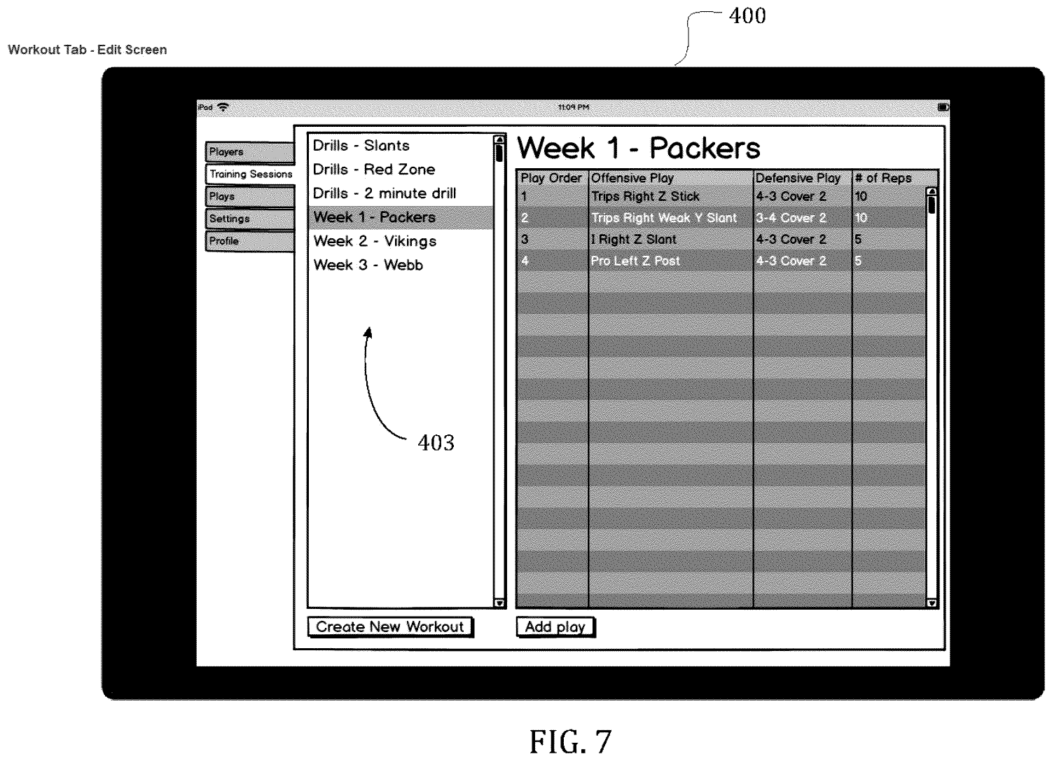

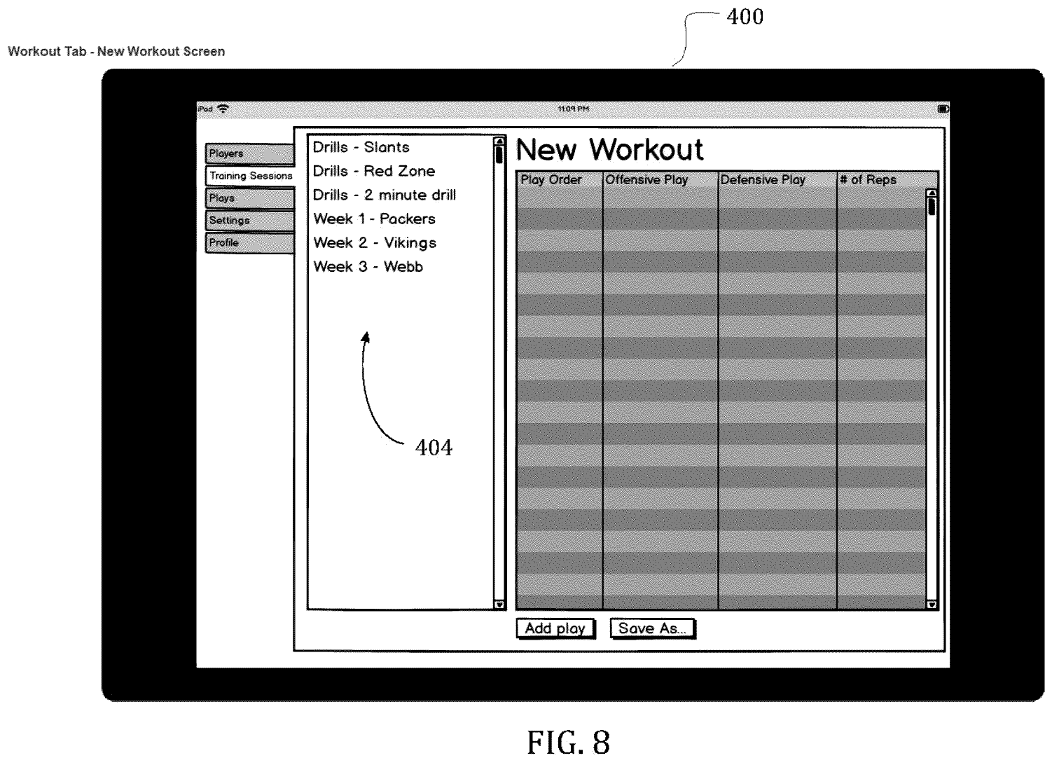

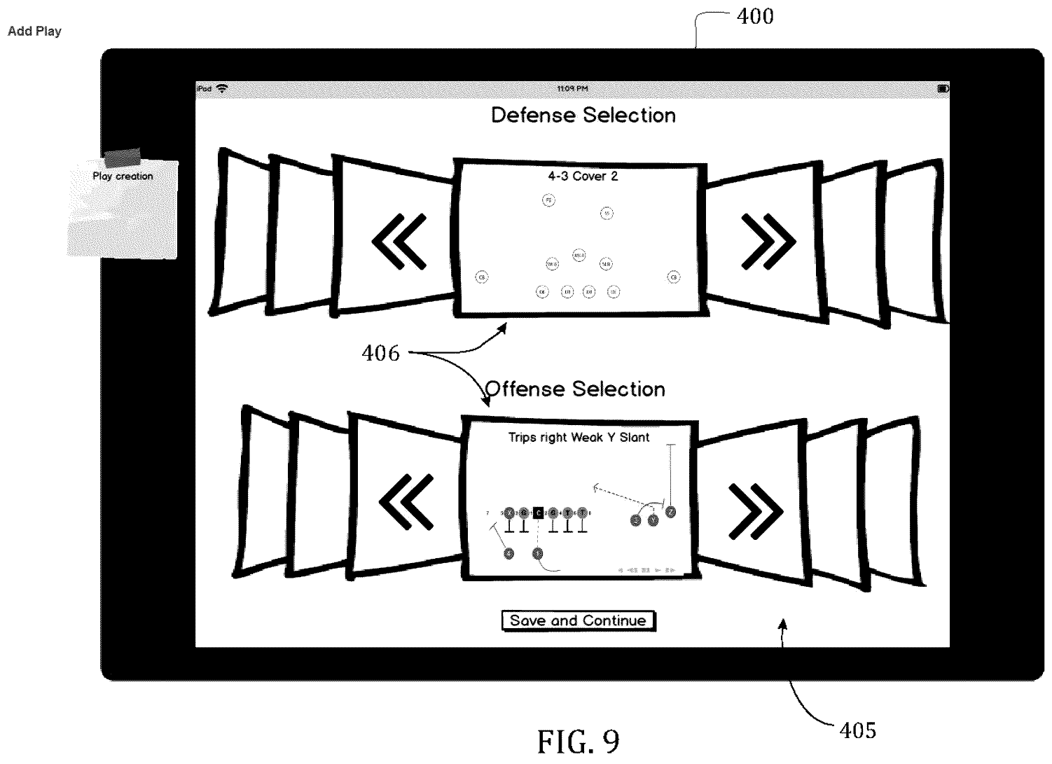

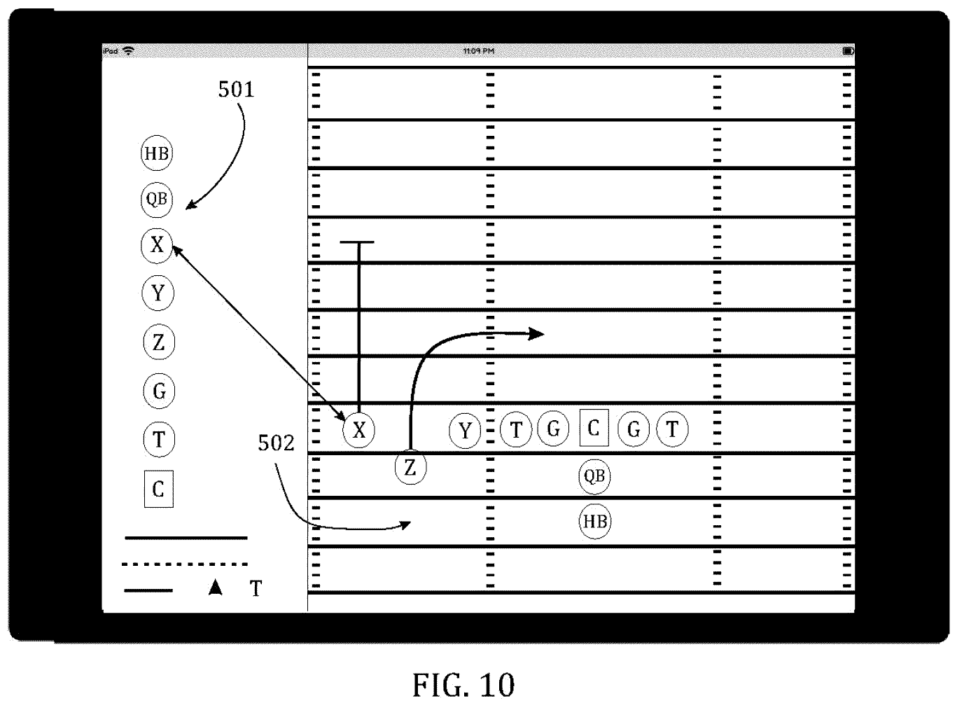

FIGS. 5-11 illustrate a user interface of a training application system according to an embodiment of the present invention. The user interface of the training application system shown is intended for the coach or trainer. In FIG. 5, after logging into the system via appropriate credentials, the coach via computing device 400 may add players 401, e.g. player users for the system. In FIGS. 6-8, via the training sessions portal 402, the coach may add 404 or edit training sessions 403, e.g. a collection of individual workouts, plays, and/or training materials. The training sessions define how the training material is presented to the users, via a schedule, order, etc. In FIG. 9, the coach may add individual plays 405 to the training sessions, wherein the individual plays are inputted in any input method previously discussed. For example, as seen in FIG. 10, via drag and drop method or in FIG. 11 via a grid method. It should be understood, other input methods may be provided.

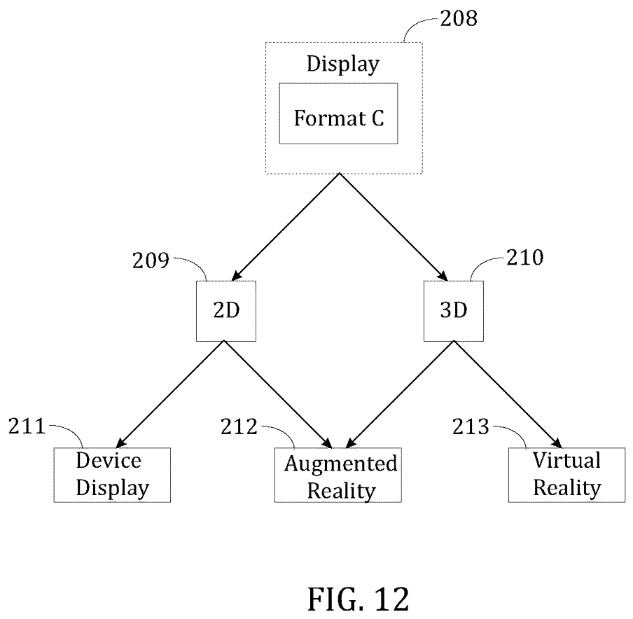

Referring now to FIG. 12, as previously mentioned, the display format 208 of the training sessions as presented to the player when executed by the system may vary. In some embodiments, the training session is presented in two dimensions (2D) 209 or three dimensions (3D) 210. In the 2D space, the training material or session may be presented via their display device 211, including but not limited to tablet, smartphone, computer, or similar device. In other embodiments, the 2D is presented in their augmented reality (AR) device 212. Likewise, in the 3D space, the training material may be presented via their augmented reality (AR) device 212 or their virtual reality (VR) device 213, such as a VR headset as known in the art.

In some embodiments, users (players) may compare their training session results to other users (players) that have completed the same training session. Advantageously, This also allows the coach or training to evaluate players competing for the same position. In one embodiment, the training session results are posted to a centralized leaderboard where scores are ranked against other users who completed the same session.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternative embodiments are contemplated, and can be made without departing from the spirit and scope of the invention. For example, the disclosure is described for the use in football, particularly American football, however one skilled in the art would appreciate that the system may be adopted for any sport or game.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

What is claimed is:

1. A customized sports training system comprising:
a training application software system executed from one or more internet-connected servers connected to a database, wherein the training application system software enables users to access the customized sports training system, the users including a coach and a player;
the customized sports training system including a design portal enabling the coach to design training material via an input method and then upload the training material to the database or the one or more internet-connected servers for storage; and,
wherein the player is enabled, via the customized sports training system, to access the stored training material during an executed training session, wherein the executed training session displays the stored training material to the player on a user device.

2. The customized sports training system of claim 1, wherein the training material includes custom designed football plays including offensive and defensive play designs.

3. The customized sports training system of claim 2, wherein the user device is an augmented reality or virtual reality device.

4. The customized sports training system of claim 1, wherein the input method of the training material is in a first format, the stored training material is in a second format, and the displayed training material is a third format.

5. The customized sports training system of claim 4, wherein the first format, the second format, and the third format is different.

6. The customized sports training system of claim 5, wherein the training application software transforms and converts the first format to the second format, and the second format to the third format.

7. The customized sports training system of claim 1, wherein the training session is a number of training materials.

8. The customized sports training system of claim 1, wherein the training materials include custom designed football plays, quizzes, scenarios, formations, and in-game situations.

9. A customized sports training system comprising:
a training application software system executed from one or more internet-connected central servers connected to a database, wherein the training application system software enables users to access the customized sports training system, the users including a coach and a player;
the coach when accessing the customized sports training system enabled to:
(a) create customized football plays;
(b) create customized training sessions comprising of one or more customized football plays; and,
(c) upload the created customized training sessions to the one or more internet-connected central servers or the database;
the player when accessing the customized sports training system enabled to:
(d) select their name or playing position;
(e) execute a previously created customized training session via a user device; and,
wherein the customized sports training system provides customized training session results after step (e) accessible by the player and the coach.

10. The customized sports training system of claim 9, further comprising step (f) posting the customized training session results to a centralized leaderboard where training session results are ranked against other users who completed the same customized training session.

11. The customized sports training system of claim 9, wherein the user device is an augmented reality or virtual reality device.

12. The customized sports training system of claim 9, wherein the customized football plays are created via an input method.

13. The customized sports training system of claim 12, wherein the input method is a drag and drop method or grid method.

14. The customized sports training system of claim 9, wherein the customized training sessions further comprise in-game scenarios, questions, or quizzes.

15. The customized sports training system of claim 9, wherein the created customized football plays are created for individual players or positions.

16. A customized sports training method comprising steps:
(a) enabling, via a training application system platform, a coach to design custom training material via an input method;
(b) uploading, via the training application system platform, the custom training material to a server or database; and,
(c) enabling, via the training application system platform, a player to execute the training material on a user device.

17. The customized sports training method of claim 16, wherein in step (a), the custom training material is for a specific playing position.

18. The customized sports training method of claim 16, wherein in step (c), wherein the player selects the specific playing position.

19. The customized sports training method of claim 16, wherein in step (a), the custom training material includes customized football plays.

20. The customized sports training method of claim 16, wherein the user device is an augmented reality or virtual reality device.
